(19) United States
(12) Patent Application Publication
(10) Pub. No.: US 2024/0249081 A1
(43) Pub. Date: Jul. 25, 2024

(54) METHOD AND SYSTEM FOR AUTOMATED CUSTOMIZED CONTENT GENERATION FROM EXTRACTED INSIGHTS

(71) Applicant: SocialTrendly, Inc. d/b/a Blackbird.AI, Rochester, NY (US)

(72) Inventors: Naushad UzZaman, Bellmore, NY (US); Paul Burkard, Kure Beach, NC (US); John Wissinger, Tucson, AZ (US); Wasim Khaled, Pittsford, NY (US)

(73) Assignee: SocialTrendly, Inc. d/b/a Blackbird.AI, Rochester, NY (US)

(21) Appl. No.: 18/421,353

(22) Filed: Jan. 24, 2024

Related U.S. Application Data
(60) Provisional application No. 63/441,057, filed on Jan. 25, 2023.

(51) Int. Cl. G06F 40/40

(52) U.S. Cl. CPC G06F 40/40

(57) ABSTRACT

Disclosed embodiments may provide techniques for generating customizable content based on extracted insights. A computer-implemented method can include accessing input data that includes initial content. The computer-implemented method can also include determining a content format of customized content to be generated by processing the input data. In some instances, the content format specifies how the customized content is to be formatted for a target recipient. The computer-implemented method can also include generating one or more prompts to be processed by a content machine-learning model for generating the customized content. The one or more prompts can be generated based on the input data and the content format. The computer-implemented method can also include applying the content machine-learning model to the one or more prompts to generate the customized content. The computer-implemented method can also include outputting the customized content.

### CROSS-REFERENCES TO RELATED APPLICATIONS

The present application claims priority from and is a non-provisional of U.S. Provisional Application No. 63/441,057, entitled “Method and System for Automated Customizable Content Generation from AI and/or Human Extracted Insights” filed Jan. 25, 2023, the contents of which are herein incorporated by reference in its entirety for all purposes.

### FIELD

The present disclosure relates generally to generating customized content from extracted insights. In one example, the systems and methods described herein may be used to generate prompts for a machine-learning model to generate customized content for a target recipient.

### SUMMARY

Disclosed embodiments may provide techniques for generating customizable content based on extracted insights. A computer-implemented method can include accessing input data that includes initial content. In some instances, the initial content is previously generated by applying an initial machine-learning model to raw data. The computer-implemented method can also include determining a content format of customized content to be generated by processing the input data. In some instances, the content format specifies how the customized content is to be formatted for a target recipient. For example, the content format can include an email, a memorandum, a slide deck, an executive briefing, or mitigation strategies.

The computer-implemented method can also include generating one or more prompts to be processed by a content machine-learning model for generating the customized content. The one or more prompts can be generated based on the input data and the content format. In some instances, generating the one or more prompts includes applying a prompt machine-learning model to the input data and the content format to generate the one or more prompts.

In some instances, the computer-implemented method also includes determining persona data that identifies characteristics associated with the target recipient and/or domain data that identifies characteristics associated with a domain associated with the customized content. The one or more prompts can be generated further based on the persona data and/or domain data.

The computer-implemented method can also include applying the content machine-learning model to the one or more prompts to generate the customized content. The computer-implemented method can also include outputting the customized content. In some instances, the computer-implemented method also includes: (i) receiving feedback associated with the customized content; and (ii) updating parameters of the content machine-learning model based on the feedback.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates an example computing environment for generating customizable content based on extracted insights, according to some embodiments.

FIG. 2 shows an illustrative example of a process for generating customizable content based on extracted insights, in accordance with some embodiments.

FIG. 3 illustrates an example schematic diagram for training and deploying a content machine-learning model for generating customized content, according to some embodiments.

FIG. 4 illustrates an example of a transformer in accordance with some embodiments.

FIG. 5 illustrates an example of a scaled dot-product attention block in a transformer in accordance with some embodiments.

FIG. 6 illustrates an example of a multi-head attention sub-layer used in the encoder and decoder of a transformer in accordance with some embodiments.

FIG. 7 illustrates an example of a bidirectional encoder representations from Transformers (BERT) model in accordance with some embodiments.

FIG. 8 illustrates an example schematic diagram for training and deploying a prompt machine-learning model for generating prompts based on initial content and content format, according to some embodiments.

FIG. 9 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Many industries rely on the ability to quickly and accurately understand large amounts of data for decision-making. For these industries, analytics and artificial intelligence (AI) service providers can produce data enrichments at scale. However, the target audience often cannot consume their output at scale, leading to a bottleneck for their operations and rendering the data enrichments less effective. Conventional techniques include manually generating reports to distill the insights from the initial data, but such processes are inefficient and time-consuming. Accordingly, there is a need for facilitating the content generation process and reducing the need for manual intervention to increase scalability. The invention claimed here solves this problem.

To address the above noted deficiencies, embodiments of the present disclosure can automatically process AI and/or human-extracted insights as input to generate customized content such as summaries, reports, and responses. The present techniques can utilize machine-learning techniques to generate natural language text in the desired content output format and can be tailored to specific personas, industries, or other use cases via customization criteria. In some instances, input prompts can be generated based on the input data to further improve performance of the machine-learning model. As a result, the automated customization of the content can reduce the need for human involvement and increase scalability.

### I. Generating Customizable Content Based on Extracted Insights

The present techniques can transform AI and/or human-extracted insights into customized content such as summaries, reports, and responses that are tailored to different personas and industries. The present techniques can include a data input module for receiving AI and/or human-extracted insights, a content format determination module for identifying the relevant persona, industry, report format, or other relevant context, and a report generation module for generating the customized content. The report-generation module can utilize a machine-learning model (e.g., a generative AI language model) to produce natural language text that is tailored for the identified use case and format. The present techniques thus utilize machine-learning techniques to transform large amounts of data into customizable content that is specific to the identified persona and industry, while still providing accurate and relevant information to the target recipients.

### A. Computing Environment

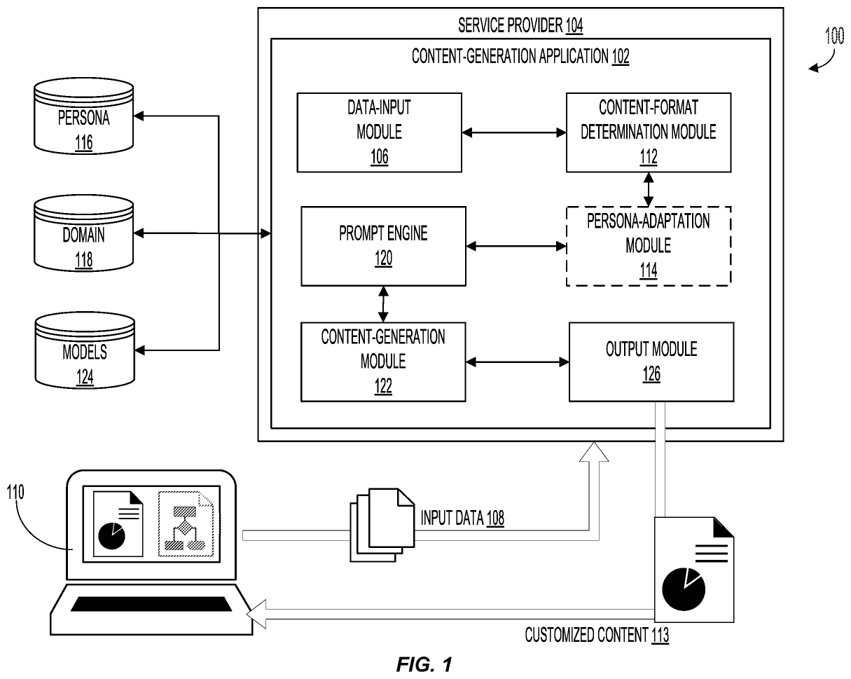

FIG. 1 illustrates an example computing environment 100 for generating customizable content based on extracted insights, according to some embodiments. In the computing environment 100, a content-generation application 102 of a service provider 104 can be configured to transform AI and/or human-extracted insights into customized content such as summaries, reports, and responses that are tailored to different personas and industries.

The content-generation application 102 can be implemented by a computer system, which can take any suitable physical form. As example and not by way of limitation, the computer system of the service provider 104, from which the content-generation application 102 is executed, can be an embedded computer system, a system-on-chip (SOC), a single-board computer system (SBC) (such as, for example, a computer-on-module (COM) or system-on-module (SOM)), a desktop computer system, a mainframe, a mesh of computer systems, a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider (e.g., the computing resources provider 928).

The content-generation application 102 can include various modules or components to transform AI and/or human-extracted insights into customized content for a target recipient. With reference to FIG. 1, the content-generation application 102 can include a data-input module 106 that accesses input data 108 that was transmitted by a user device 110. The input data 108 can include an initial content, which include text, images, and/or other types of data that can be processed and formatted to generate customized content. The initial content can include content generated by applying an initial machine-learning model to raw data provided by the target recipient and/or another user (e.g., an administrator of the service provider 104). For example, the raw data can include network activity of an entity associated with the target recipient, at which the initial content can include risk metrics of the entity over a period of time at which the raw data was collected. In some instances, the initial content is generated by a third-party system (not shown), such as another AI service provider.

The input data 108 can be transmitted across a communication network. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IOT network) or any other such network or combination of networks. Communications by the client device via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

The user device 110 can be a client device that includes a desktop computer system, a laptop or notebook computer system, a tablet computer system, a wearable computer system or interface, an interactive kiosk, a mainframe, a mesh of computer systems, a mobile telephone, a personal digital assistant (PDA), or a combination of two or more of these.

The content-generation application 102 can include a content-format determination module 112 that determines a content format of customized content 113 to be generated by processing the input data. The content format can specify how the customized content is to be formatted for a target recipient. Examples of the content format can include an email, a memorandum, a slide deck, an executive briefing, spreadsheets, or mitigation strategies (e.g., media buying, media messaging, media approach, PR strategy, PR approach). The content format can be specific to a technology field, including: (i) customized scripts, story summaries, and character descriptions for movies, TV shows, and video games in the field of media and entertainment; (ii) customized study materials, summaries, and quizzes for students in the field of education; (iii) automated responses for frequently asked questions, personalized customer service emails, and customer service reports in the field of customer service; (iv) customized reports, summaries, and recommendations for optimizing transportation routes, inventory management, and supply chain management in the field of transportation and logistics; (v) personalized product recommendations, product summaries, and customer reviews in the field of e-commerce; and (vi) customized resumes, job descriptions, and employee performance evaluations in the field of human resources.

In some instances, the content-format determination module 112 determines the content format based on: (i) a data type associated with the initial content of the input data 108; and (ii) one or more characteristics associated with the target recipient. For example, the content-format determination module 112 can apply one or more data-processing rules to the initial content to select the spreadsheet format for the customized content 113. In another example, the content-format determination module 112 can apply a content-format machine-learning model (e.g., an artificial neural network, k-means algorithm) to the input data 108 to determine the executive-briefing format for the customized content 113.

In some instances, the content format is identified based on interactions performed by the user of the user device 110. For example, the user can select a particular content format from options displayed on a graphical user interface (e.g., a drop-down menu, radio buttons) of the user device 110. In some instances, the user can identify the particular content format by using application programming interfaces (APIs). For example, an API message can be transmitted from the user device 110 using an API protocol such as Hypertext Markup Language (HTML), Extensible Markup Language (XML), JavaScript®, Cascading Style Sheets (CSS), JavaScript® Object Notation (JSON), and other such protocols and/or structured languages. The API message transmitted by the user device 110 can include an identifier associated with the input data 108 and one or more content formats associated with the customized content. The data-input module 106 can parse the API message to generate an API response indicating that the content-generation application 102 will proceed with generating the customized content in accordance with the selected content format.

The content-generation application 102 can include a persona-adaptation module 114 that can optionally generate supplemental data that identifies various characteristics associated with the target recipient. In some instances, the persona-adaptation module 114 accesses persona data from a persona database 116, in which the persona data identifies characteristics associated with the target recipient. For example, the persona data can include characteristics associated with employee roles including chief executive officer (CEO), chief information security officer (CISO), chief communications officer (CCO), chief marketing officer (CMO), and analyst. Additionally or alternatively, the persona-adaptation module 114 can access domain data from a domain database 118, in which the domain data identifies characteristics associated with a domain associated with the customized content 113. For example, the domain data can include cybersecurity, national security, healthcare, finance, energy, media and entertainment, pharmaceuticals, consumer goods, and environment.

The content-generation application 102 can include a prompt engine 120 that generates one or more prompts to be processed by a content machine-learning model for generating the customized content 113. Prompts can be used as a means for the content-generation application 102 to interact with the content machine-learning model to accomplish a task. In some instances, the prompts generated by the prompt engine 120 can be modified via a user-provided input. Example prompts can include instructions, questions, or any other types of text input.

The one or more prompts can thus be generated to specify the content format and customization information that should be included in the customized content 113. In some instances, the prompt engine 120 generates the one or more prompts based on the input data and the content format. The use of the prompt engine facilitates querying the content machine-learning model with “insight prompts” that were determined from the initial content (e.g., specialized risk metrics from the raw data) extracted by previous AI tools. As a result, the content machine-learning model is not merely summarizing data, but captures the specialized insights based on the prompts generated by the prompt engine 120.

In some instances, the prompt engine 120 generates the one or more prompts by applying a prompt machine-learning model to the input data and the content format. The prompt machine-learning model can further generate the one or more prompts additionally based on the supplemental data (e.g., persona data, the domain data) generated by the persona-adaptation module 114. The prompt machine-learning model can be a natural-language processing model trained using the previous input data and corresponding prompts generated based on the previous input data. Examples of the prompt machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the prompt machine-learning model can include, but are not limited to, genetic algorithms, backpropagation, reinforcement learning, decision trees, linear classification, artificial neural networks, anomaly detection, and such. In yet other examples, the prompt machine-learning model may include regression analysis, dimensionality reduction, metalearning, reinforcement learning, deep learning, and other such algorithms and/or methods. Additional implementation details for using the prompt machine-learning model to generate the one or more prompts are described in Section III of the present disclosure.

The content-generation application 102 can include a content-generation module 122 applying the content machine-learning model to the one or more prompts to generate the customized content 113. In some instances, the content machine-learning model is a large-language model (LLM) obtained from a models database 124. In some instances, the content machine-learning model is trained using self-supervised learning based on a large corpus of text data, such that the content machine-learning model can generate the customized content 113 by taking an input text and repeatedly predicting the next token or word. In addition to training the model, the prompts generated by the prompt engine 120 can be used for prompt engineering of the content machine-learning model for generating the customized content 113. Examples of the content machine-learning model can include, but are not limited to, BERT model, Claude LLM, Falcon 40B, Ernie, GPT-3, GPT-3.5, GPT 4, Lamda, and Llama. Additional implementation details for using the content machine-learning model to generate the customized content 113 are described in Section II of the present disclosure.

The content-generation application 102 can include an output module 126 that outputs the customized content 113. In some instances, the customized content 113 is outputted to a web page, a mobile-application interface, or other platforms that can be accessed by the user device 110. The customized content 113 can thus not only capture the information from the initial content, but also formatted to the target recipient as specified in the content format. For example, the customized content 113 can include a risk narrative report for a Chief Information Officer, in which the customized content 113 was generated based on the risk metrics identified from the initial content of the input data 108. In another example, the customized content 113 can be a slide presentation that can be generated to include content specifically tailored to a CMO of the organization. In yet another example, the customized content 113 can be a spreadsheet that can be generated to include content specifically tailored to an analyst of the organization.

In some instances, the user of the user device 110 can modify the customized content 113 before transmitting the customized content 113 to the target recipient, in which the modifications can be used as feedback for updating parameters of the content machine-learning model. To facilitate the editing process, an editing module (not shown) can be integrated into the content-generation module 122 for real-time review and editing of the customized content 113. As a result, the initial content of the input data 108 can be processed using machine-learning techniques to generate natural language text in the desired content output format, which can be further tailored to specific personas, industries, or other use cases via customization criteria.

The customized content can be implemented in various systems and applications including (for example): (1) application servers that can generate the customized content in various formats such as summaries, reports, and responses, tailored to specific personas, industries, or other use cases. The customized content can include executive briefings, slide presentations, email communications, memos, and mitigation strategies; (2) automated report-generation systems that can be used by organizations and individuals to generate the customized content at scale; (3) AI-driven report-generation and response-generation systems that can be used by organizations and individuals to generate the customized content based on initial content generated by AI and machine learning technologies; (4) natural-language generation systems that can be used by organizations and individuals to generate the customized content that include natural-language text in various formats and languages; and (5) generative AI report-generation systems that use generative AI language models to generate natural language text in various formats and languages.

Other examples of the customized content being implemented in various systems and applications can include: (1) customized report-generation automation systems that can be used by organizations and individuals to automate the process of generating customized content; (2) insights analysis systems that can be used by organizations and individuals to analyze data and extract insights that can be used to improve the generated content; (3) automated response generation systems that can be used by organizations and individuals to generate automated responses to various types of requests; (4) AI-driven response generation systems that can be used by organizations and individuals to generate automated responses using AI and machine learning technologies; (5) software applications or services that can be used to implement the invention and generate customized content; and (6) an API service that can be integrated with other systems to provide the users automated customizable content generation functionality.

In some instances, the content-generation application 102 can generate the customized content 113 specific for different fields of technology. For example, the content-generation application 102 can: (i) generate customized scripts, story summaries, and character descriptions for movies, TV shows, and video games in the field of media and entertainment; (ii) generate customized study materials, summaries, and quizzes for students in the field of education; (iii) generate automated responses for frequently asked questions, personalized customer service emails, and customer service reports in the field of customer service; (iv) generate customized reports, summaries, and recommendations for optimizing transportation routes, inventory management, and supply chain management in the field of transportation and logistics; (v) generate personalized product recommendations, product summaries, and customer reviews in the field of e-commerce; and (vi) generate customized resumes, job descriptions, and employee performance evaluations in the field of human resources. In sum, the content-generation application 102 can be applied to a wide range of fields and industries where automated report generation and natural language generation are needed and can be adapted to different use cases by providing different inputs, persona, industry, and other information.

After providing the output, the content-generation application 102 can later receive feedback associated with the customized content. The feedback can indicate whether the customized content is accepted, rejected, or modified. In some instances, the feedback further includes text data provided by the target recipient describing the quality of the customized content (e.g., good, too much information, contains unsupported data, content-format incorrect). Based on the feedback, the content-generation application 102 can further train the content machine-learning model based on the feedback via reinforcement learning.

### B. Methods

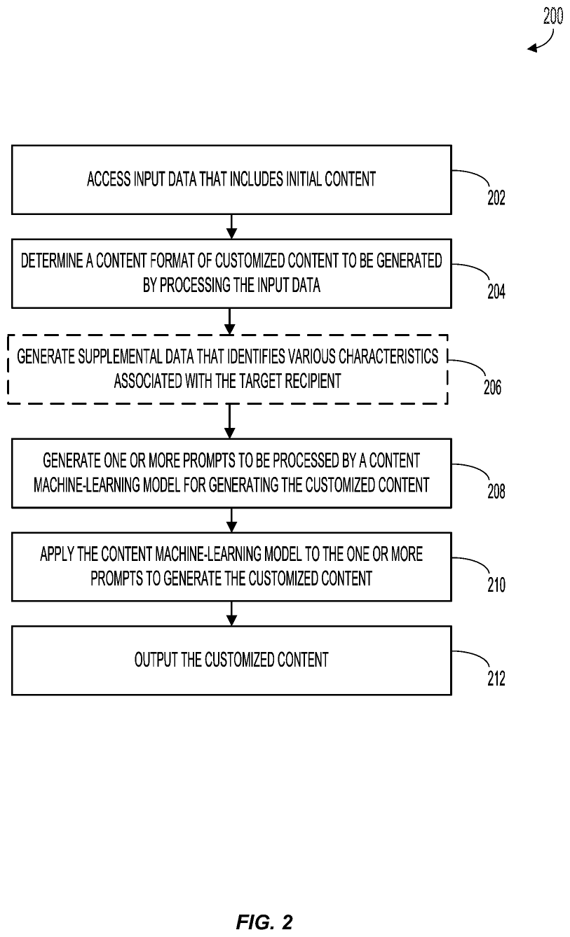

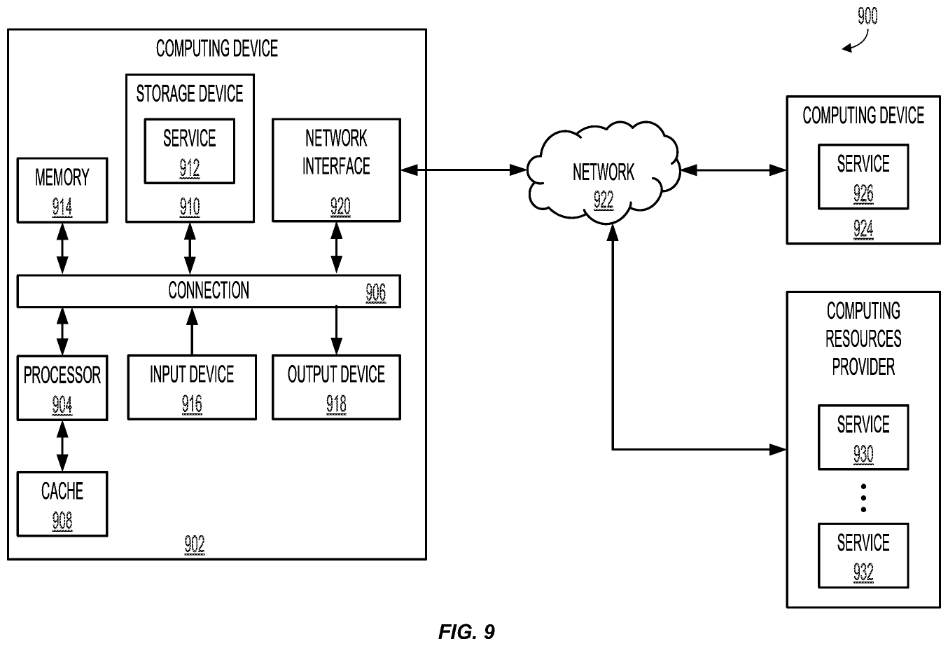

FIG. 2 shows an illustrative example of a process 200 for generating customizable content based on extracted insights, in accordance with some embodiments. For illustrative purposes, the process 200 is described with reference to the components illustrated in FIG. 1, though other implementations are possible. For example, the program code for the content-generation application 102 of FIG. 1 is executed by one or more processing devices to cause a server system (e.g., the computing device 902 of FIG. 9) to perform one or more operations described herein.

At step 202, the content-generation application can access input data that includes initial content. The initial content can include text, images, and/or other types of data that can be processed and formatted to generate customized content. In some instances, the initial content includes content generated by applying an initial machine-learning model to raw data provided by the target recipient and/or another user. For example, the raw data can include network activity of an entity associated with the target recipient, at which the initial content can include risk metrics of the entity over a period of time at which the raw data was collected. In some instances, the initial content is generated by a third-party system, such as another AI service provider.

At step 204, the content-generation application can determine a content format of customized content to be generated by processing the input data. In some instances, the content format specifies how the customized content is to be formatted for a target recipient. The content format can specify how the customized content is to be formatted for a target recipient. Examples of the content format can include an email, a memorandum, a slide deck, an executive briefing, spreadsheets, or mitigation strategies (e.g., media buying, media messaging, media approach, PR strategy, PR approach).

In addition, the content format can be specific to a technology field, including: (i) customized scripts, story summaries, and character descriptions for movies, TV shows, and video games in the field of media and entertainment; (ii) customized study materials, summaries, and quizzes for students in the field of education; (iii) automated responses for frequently asked questions, personalized customer service emails, and customer service reports in the field of customer service; (iv) customized reports, summaries, and recommendations for optimizing transportation routes, inventory management, and supply chain management in the field of transportation and logistics; (v) personalized product recommendations, product summaries, and customer reviews in the field of e-commerce; and (vi) customized resumes, job descriptions, and employee performance evaluations in the field of human resources.

In some instances, the content-generation application determines the content format based on: (i) a data type associated with the initial content of the input data; and (ii) one or more characteristics associated with the target recipient. In some instances, the content format is identified based on interactions performed by the user of a user device. For example, the user can select a particular content format from options displayed on a graphical user interface (e.g., a drop-down menu, radio buttons) of the user device. Additionally or alternatively, a content-format machine-learning model (e.g., an artificial neural network, k-means algorithm) can be applied to the input data to determine the content format of the customized content.

At an optional step 206, the content-generation application can generate supplemental data that identifies various characteristics associated with the target recipient. In some instances, the supplemental data includes persona data that identifies characteristics associated with the target recipient. For example, the persona data can include characteristics associated with employee roles including chief executive officer (CEO), chief information security officer (CISO), chief communications officer (CCO), chief marketing officer (CMO), and analyst. Additionally or alternatively, the supplemental data can include domain data that identifies characteristics associated with a domain associated with the customized content. For example, the domain data can include cybersecurity, national security, healthcare, finance, energy, media and entertainment, pharmaceuticals, consumer goods, and environment.

At step 208, the content-generation application can generate one or more prompts to be processed by a content machine-learning model for generating the customized content. In some instances, the one or more prompts are generated based on the input data and the content format. In some instances, the content-generation application the one or more prompts by applying a prompt machine-learning model to the input data and the content format. The prompt machine-learning model can be a natural-language processing model trained using the previous input data and corresponding prompts generated based on the previous input data. The prompt machine-learning model can further generate the one or more prompts additionally based on the supplemental data (e.g., persona data, the domain data).

At step 210, the content-generation application can apply the content machine-learning model to the one or more prompts to generate the customized content. In some instances, the content machine-learning model is a large-language model (LLM). Examples of the content machine-learning model can include, but are not limited to, BERT model, Claude LLM, Falcon 40B, Ernie, GPT-3, GPT-3.5, GPT 4, Lamda, and Llama.

At step 212, the content-generation application can output the customized content. In some instances, the customized content is outputted to a web page, a mobile-application interface, or other platforms that can be accessed by the user device. For example, the customized content can include a risk narrative report for a Chief Information Officer, in which the customized content was generated based on the risk metrics identified from the initial content of the input data.

After providing the output, the content-generation application can later receive feedback associated with the customized content. The feedback can indicate whether the customized content is accepted, rejected, or modified. In some instances, the feedback further includes text data provided by the target recipient describing the quality of the customized content (e.g., good, too much information, contains unsupported data, content-format incorrect). Based on the feedback, the content-generation application can further train the content machine-learning model (e.g., update parameters of the content machine-learning model) based on the feedback via reinforcement learning. Process 200 terminates thereafter.

### II. Machine-Learning Techniques for Generating Customized Content

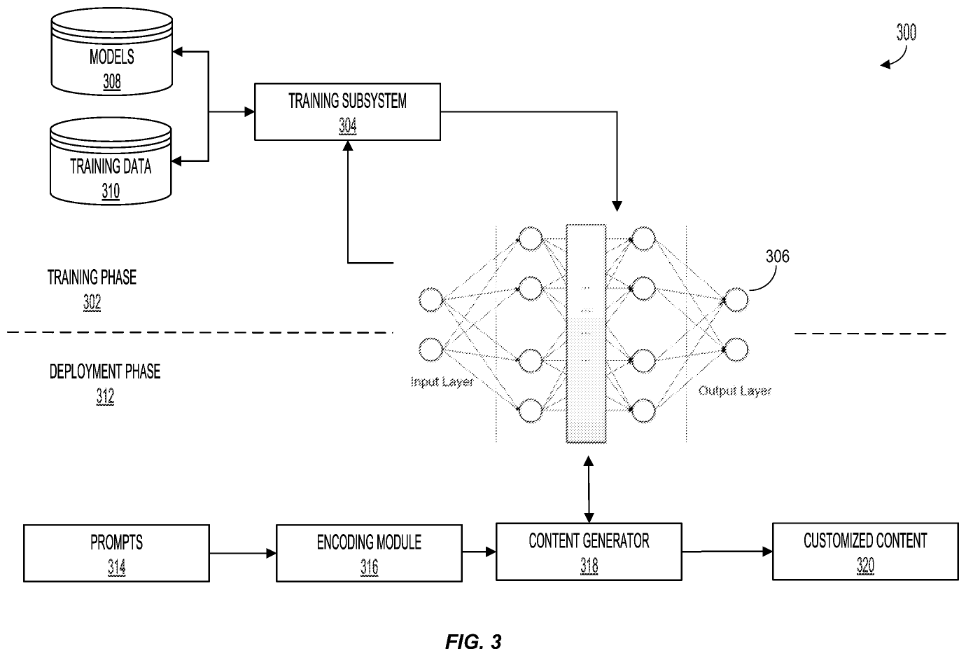

FIG. 3 illustrates an example schematic diagram 300 for training and deploying a content machine-learning model for generating customized content, according to some embodiments. As shown in FIG. 3, machine-learning techniques for generating customized content can be initiated by a training subsystem 304 accessing an initial machine-learning model 306 from a models database 308 (e.g., a training phase 302). As an illustrative example, the content machine-learning model 306 can be a transformer model selected from the models database 308, which is described further below.

### A. Model Selection

### 1. BERT Architecture

A BERT model uses Masked Language Modeling (MLM), a self-supervised pre-training objective that allows a transformer encoder to encode a sequence from both directions simultaneously. Specifically, for an input sequence S=(w₁, . . . , w_{N}) of N tokens, BERT first randomly masks out 15% of the tokens and then predicts the masked tokens in the output. The masked tokens in the input sequence are represented by a special symbol [MASK] and fed into a multi-layer transformer encoder. For example, let H^{l}=(h₁, . . . , h_{N}) be the encoded features at the 1-th transformer layer, with 11° being the input layer. The features at the (l+1)-th layer are obtained by applying a transformer block defined as:

$${H}^{l + 1} = LN ( LN ( {H}^{l} + {f}_{Self - Att}^{l} ( {H}^{l} ) ) + {f}_{FF}^{l} ( LN ( {H}^{l} ( {H}^{l} + {f}_{Self - Att}^{l} ( {H}^{l} ) ) ) )$$

where LN stands for layer normalization, f_{self-Att}^{l}(·) is a multi-headed self-attention sub-layer, f_{FF}(·) is a feed-forward sub-layer composed of two fully-connected (FC) layers, wrapped in residual connection with an LN. The token representations in the final layer are used to predict the masked tokens independently.

### 2. BERT Implementation

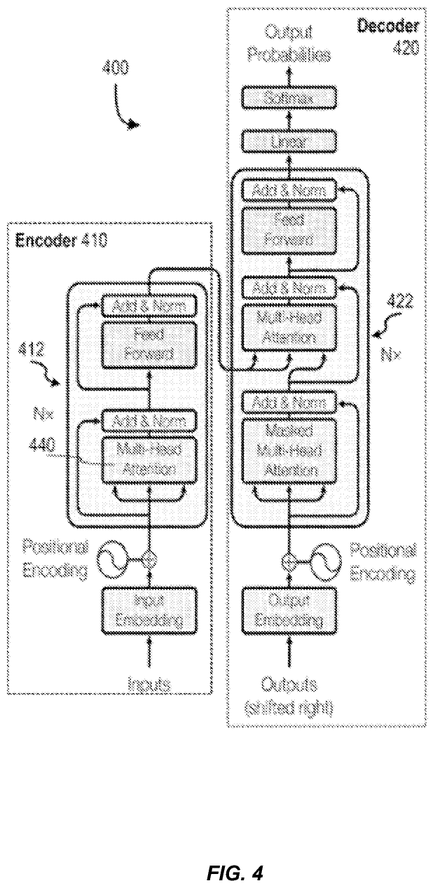

FIG. 4 illustrates an example of a transformer 400 in accordance with some embodiments. Transformer 400 may include an encoder 410 and a decoder 420. Encoder 410 may include a stack of N layers 412. Each layer 412 may include two sub-layers that perform matrix multiplications and element-wise transformations. The first sub-layer may include a multi-head self-attention network, and the second sub-layer may include a position-wise fully connected feed-forward network. A residual connection may be used around each of the two sub-layers, followed by layer normalization. A residual connection adds the input to the output of the sub-layer, and is a way of making training deep networks easier. Layer normalization is a normalization method in deep learning that is similar to batch normalization. The output of each sub-layer may be written as LN(x+Sublayer(x)), where Sublayer(x) is the function implemented by the sub-layer. In the encoder phase, the Transformer first generates initial inputs (e.g., input embedding and position encoding) for each word in the input sentence. For each word, the self-attention aggregates information from all other words (pairwise) in the context of the sentence to create a new representation for each word that is an attended representation of all other words in the sequence. This is repeated for multiple times each word in a sentence to successively build newer representations on top of previous ones.

Decoder 420 may also include a stack of N layers 422. In addition to the two sub-layers in each encoder layer 412 described above, each layer 422 in decoder 420 may include a third sub-layer that performs multi-head attention over the output of the encoder stack. Similar to layers 412 in encoder 410, residual connections around each of the sub-layers may be used in layers 422 in decoder 420, followed by layer normalization. The self-attention sub-layer in the decoder stack may be modified (labeled as “masked multi-head attention”) to mask inputs to the decoder from future time steps and prevent positions from attending to subsequent positions. The masking, combined with offsetting the output embeddings by one position, ensures that the predictions for position i can depend only on the known outputs at positions less than i. Decoder 420 may generate one word at a time from left to right. The first word generated at a layer may be based on the final representation of the encoder (offset by 1 position). Every word predicted subsequently may attend to the previously generated words at that layer of the decoder and the final representation of the encoder.

An attention function may map a query and a set of key-value pairs to an output, where the query, keys, values, and output are all vectors. A query vector q encodes the word/position that is paying attention. A key vector k encodes the word to which attention is being paid. The key vector k and the query vector q together determine the attention score between the respective words. The output is computed as a weighted sum of values, where the weight assigned to each value is computed by a compatibility function of the query with the corresponding key.

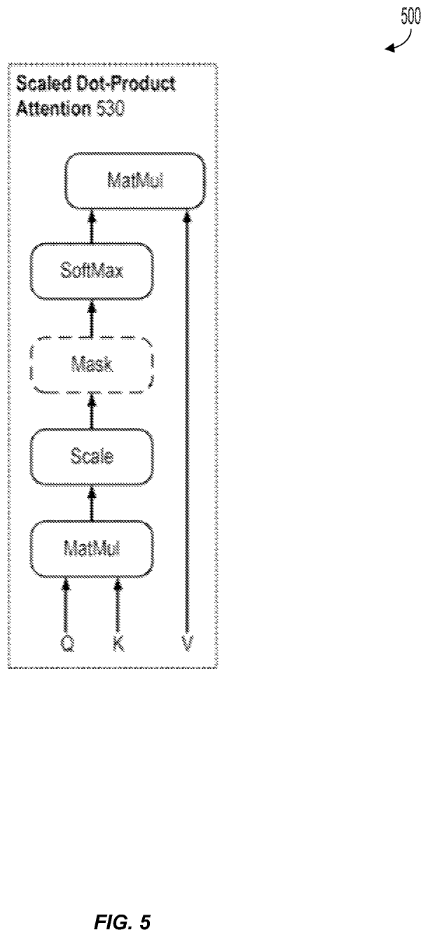

FIG. 5 illustrates an example of a scaled dot-product attention 530 in accordance with some embodiments. The scaled dot-product attention 530 is one of the attention mechanisms that can be used by an encoding layer 412 of the transformer 400. In scaled dot-product attention block 530, the input includes queries and keys both of dimension dₖ, and values of dimension dy. The scaled dot-product attention may be computed on a set of queries simultaneously, according to the following equation:

$$Attention ( Q , K , V ) = softmax ( \frac{{QK}^{T}}{\sqrt{{d}_{k}}} ) V ,$$

where Q is the matrix of queries packed together, and K and I are the matrices of keys and values packed together. The scaled dot-product attention computes the dot-products (attention scores) of the queries with all keys (“MatMul”), divides each element of the dot-products by a scaling factor \sqrt{dₖ} (“scale”), applies a softmax function to obtain the weights for the values, and then uses the weights to determine a weighted sum of the values.

When only a single scaled dot-product attention 530 is used to calculate the weighted sum of the values, it can be difficult to capture various different aspects of the input. For instance, in the sentence “I like cats more than dogs,” one may want to capture the fact that the sentence compares two entities, while retaining the actual entities being compared. To address this issue, the transformer 400 uses the multi-head self-attention sub-layer to allow the encoder and decoder to see the entire input sequence all at once. To learn diverse representations, the multi-head attention applies different linear transformations to the values, keys, and queries for each attention head, where different weight matrices may be used for the multiple attention heads and the results of the multiple attention heads may be concatenated together.

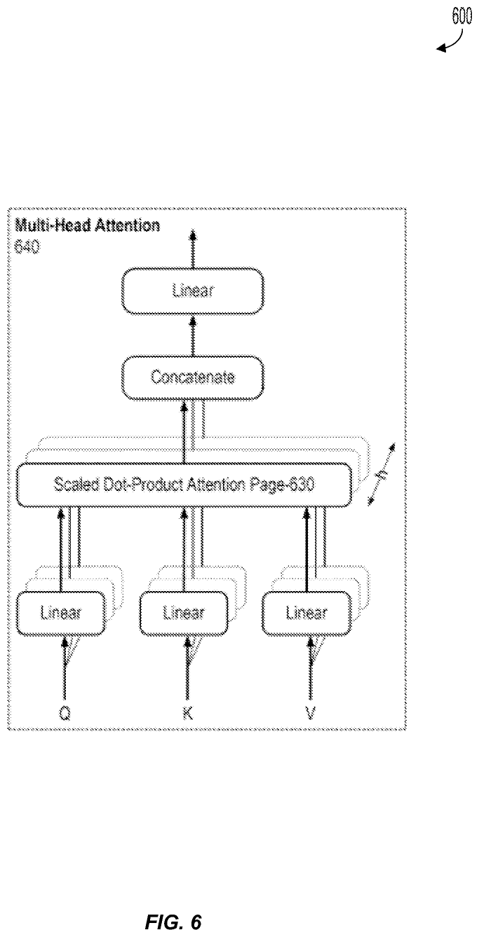

FIG. 6 illustrates an example of a multi-head attention sub-layer 640 used in encoder 610 and decoder 620 of transformer 600 described above. The multi-head attention sub-layer 640 includes a multi-head mechanism in which several scaled dot-product attentions 630 (e.g., the scaled dot-product attention 530 of FIG. 5) process input data in parallel. Instead of performing a single attention function with d_{model}-dimensional keys, values, and queries, multi-head self-attention sub-layer 640 linearly projects the queries, keys, and values multiple (e.g., h) times with different, learned linear projections to dₖ, dₖ, and dᵥ, respectively. Attention functions are performed in parallel on the h projected versions of queries, keys, and values using multiple (e.g., h) scaled dot-product attentions, yielding (h×dᵥ)-dimensional output values. Each attention head may have a structure as shown in FIG. 5, and may be characterized by three different projections given by weight matrices:

$${W}_{i}^{K} with dimensions {d}_{model} \times {d}_{k} \\ {W}_{i}^{Q} with dimensions {d}_{model} \times {d}_{k} \\ {W}_{i}^{V} with dimensions {d}_{model} \times {d}_{v}$$

The outputs of the multiple scaled dot-product attentions are concatenated, resulting in a matrix of dimensions dᵢ×(h×dᵥ), where dᵢ is the length of the input sequence. Afterwards, a linear layer with weight matrix W° of dimensions (h×dᵥ)×dₑ is applied to the concatenation result, leading to a final result of dimensions dᵢ×dₑ:

$$MultiHead ( Q , K , V ) = Concat ( {head}_{1} , … , {head}_{h} ) {W}^{o} \\ where {head}_{i} = Attention ( {QW}_{i}^{Q} , {KW}_{i}^{K} , {VQ}_{i}^{V} )$$

where dₑ is the dimension of the token embedding. Multi-head attention allows a network to jointly attend to information from different representation subspaces at different positions. The multi-head attention may be performed using a tensor operation, which may be split into multiple sub-operations (e.g., one for each head) and performed in parallel by multiple computing engines as described above.

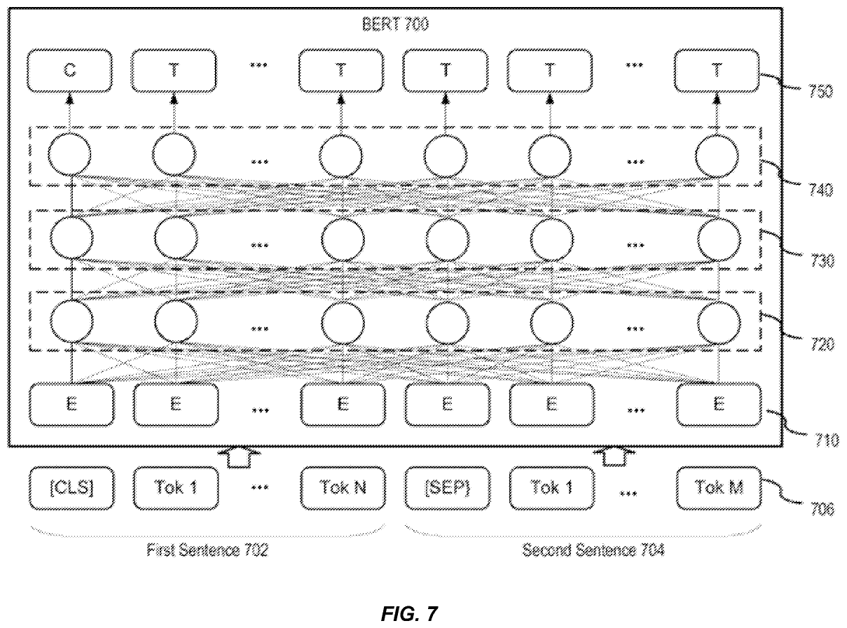

FIG. 7 illustrates an example of a BERT model 700 in accordance with some embodiments. A BERT model may include a multi-layer bidirectional Transformer encoder (rather than a left-to-right Transformer encoder), and does not include the Transformer decoder because the BERT model is used to generate a language model. The BERT model is designed to pre-train deep bidirectional representations from unlabeled text by jointly conditioning on both the left and right context in all layers. The pre-trained BERT model can be fine-tuned with an additional output layer to create state-of-the-art models for a wide range of tasks, such as question answering and language inference, without substantial task-specific architecture modifications. BERT alleviates the unidirectionality constraint by using a MLM pre-training objective. The masked language model randomly masks some of the tokens from the input, and the objective is to predict the original vocabulary identification (Id) of the masked word based only on its context. Unlike the left-to-right language model pre-training, the MLM objective enables the representation to fuse the left and the right context, which allows pre-training a deep bidirectional Transformer. In addition to the masked language model, a “next sentence prediction” task can be used to jointly pre-train text-pair representations.

In the example shown in FIG. 7, the BERT model 700 uses inputs that include a sequence of tokens 706, which may include one or more sentences, such as first sentence 702 and second sentence 704. In some embodiments, some (e.g., about 15% of) tokens 706 may be masked. Input tokens 706 may be embedded into vectors 710 and processed by encoder layers 720, 730, and 740 to generate a sequence of tokens 750 each represented by a vector. Encoder layers 720, 730, . . . , and 740 may form a multi-layer perceptron. Each encoder layer 720, 730, . . . , or 740 may be similar to encoder layers 412 and may include the multi-head attention model and/or fully connected layer. The multi-head attention model may include multiple dot-product attentions. Operations of each encoder layer 720, 730, or 740 may include a tensor operation that can be split into sub-operations that have no data dependency between each other and thus can be performed by multiple computing engines (e.g., accelerators) in parallel as described above.

In addition to the BERT model, other types of the content machine-learning model can be selected, including Claude LLM, Falcon 40B, Ernie, GPT-3, GPT-3.5, GPT 4, Lamda, and Llama. For example, the content machine-learning model can be a GPT-4 model which can include trillions of parameters that can process both language and images to generate the customized content.

### B. Training

Referring back to FIG. 3, once the content machine-learning model 306 is selected, the training subsystem 304 can train the content machine-learning model 306 using a training dataset accessed from a training database 310. Various training and test data sets may be utilized to train the machine-learning model such that once trained, the content machine-learning model 306 can generate the customized content (e.g., the customized content 113 of FIG. 1) based the prompts generated by a prompt engine (e.g., the prompt engine 120 of FIG. 1). In some instances, the training dataset can include a large corpus of text data (e.g., unlabeled data such as books, research papers and Wikipedia articles).

A large pool of data accessed from the training database 310 may be split into two classes of data called training data set and test data set. For example, 70% of the accessed data from the pool may be used as part of the training data set while the remaining 30% of the accessed data from the pool may be used as part of the test data set. The percentages according to which the pool of the data are split into training data set and test data set is not limited to 70/30 and may be set according to a configurable accuracy requirement and/or error tolerance (e.g., the split can be 50/50, 60/40, 70/30, 80/20, 90/10, etc. between the two data sets).

The training subsystem can then use the training dataset to train the content machine-learning model 306 by calculating a loss based on a comparison between an actual output generated from the machine-learning model and an expected output of the content machine-learning model. With each output generated by the content machine-learning model 306, the expected output can thus be used to correct the actual output of the content machine-learning model 306. In some instances, manual feedback is further utilized to adjust the corresponding parameters of the machine-learning model. As noted, weights of different nodes of the content machine-learning model 306 may be adjusted/tuned during the training process to improve resulting output.

During training, weights of nodes associated with the content machine-learning model 306 can be adjusted using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned. In particular, the training of the content machine-learning model 306 (e.g., adjustment of the weights) can be performed until a corresponding loss (e.g., a mean square error) reaches a minimum threshold.

Once trained, the training subsystem 304 can test the content machine-learning model 306 using the test data set. Examples of testing methods can include regression testing, unit testing, beta testing, and alpha testing. In some instances, the content machine-learning model 306 can be fine-tuned with an additional output layer to create state-of-the-art models for a wide range of tasks, such as question answering and language inference, without substantial task-specific architecture modifications.

Once the result of testing the content machine-learning model 306 is satisfactory (e.g., when outputs of the testing stage is greater than or equal to a threshold or incorrect detections are less than a threshold), the training subsystem 304 can deploy the trained machine-learning model 306 (which may also be referred to as a trained machine learning model or machine trained neural network) to a content generator 318, which can use the trained content machine-learning model 306 to generate customized content based on the input prompts.

### C. Deployment

After accessing the trained content machine-learning model 306, the content-generation can proceed with a deployment phase 312, in which the content generator 318 applies the trained machine-learning model 306 to input data to generate customized content 320 based on the prompts 314. The input data for the trained content machine-learning model 306 can include one or more prompts 314. The prompts 314 can include text data for querying the content machine-learning model 306 to generate the customized content 320. In some instances, the prompts can be modified via a user-provided input. Example prompts can include instructions, questions, or any other types of text input. The prompts 314 can be generated based on initial content and content format specified for a target recipient, the implementation details of which are further described in Sections I and III of the present disclosure.

In some instances, an encoding module 316 can encode the prompts 314 to generate a feature vector. The feature vector can include a set of values (e.g., a numerical array) that represent the input data, in which the feature vector can be used as input to the content machine-learning model 306. Example techniques for generating feature vectors can include term frequency-inverse document frequency (TF-IDF) techniques, word-embedding techniques, and tokenization techniques.

The content generator 318 can then apply the trained content machine-learning model 306 (e.g., the neural network) to the feature vector to generate the customized content 320. The customized content 320 can include natural language text in the desired content output format (e.g., mitigation strategies), which can be further tailored to specific personas, industries, or other use cases via customization criteria.

As described herein, the customized content 320 can be implemented in various systems and applications including (for example): (1) application servers that can generate the customized content in various formats such as summaries, reports, and responses, tailored to specific personas, industries, or other use cases. The customized content can include executive briefings, slide presentations, email communications, memos, and mitigation strategies; (2) automated report-generation systems that can be used by organizations and individuals to generate the customized content at scale; (3) AI-driven report-generation and response-generation systems that can be used by organizations and individuals to generate the customized content based on initial content generated by AI and machine learning technologies; (4) natural-language generation systems that can be used by organizations and individuals to generate the customized content that include natural-language text in various formats and languages; and (5) generative AI report-generation systems that use generative AI language models to generate natural language text in various formats and languages.

III. Machine-Learning Techniques for Generating Prompts Associated with Generating Customized Content

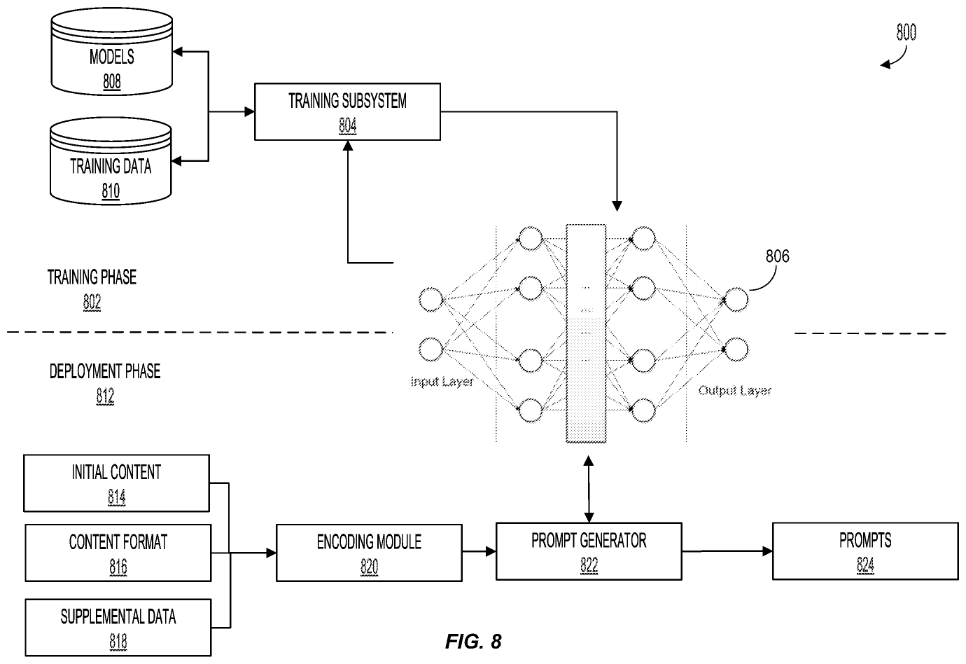

FIG. 8 illustrates an example schematic diagram 800 for training and deploying a prompt machine-learning model for generating prompts based on initial content and content format, according to some embodiments. The one or more prompts can thus be generated to specify the content format and customization information that should be included in the customized content. The use of the prompt engine facilitates querying the content machine-learning model with “insight prompts” that were determined from the initial content (e.g., specialized risk metrics from the raw data) extracted by previous AI tools. As a result, the content machine-learning model is not merely summarizing data, but captures the specialized insights based on the prompts generated by the prompt engine.

### A. Model Selection

As shown in FIG. 3, the machine-learning techniques for generating prompts based on initial content and content format can include training a given machine-learning model (e.g., a natural-language processing model) to facilitate the generation of prompts that can be used by an LLM to generate customized content (e.g., a training phase 802). The training phase 802 can be initiated by a training subsystem 804 accessing an initial prompt machine-learning model 806 from a models database 808. As an illustrative example, the prompt machine-learning model 806 can be an artificial neural network selected from the models database 808. The neural network can be defined by an example neural network description for machine learning in a neural controller, which can be the same as a processing unit inside a mobile device. Neural network description can include a full specification of the neural network, including the neural architecture. For example, the neural network description can include a description or specification of architecture of the neural network (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc. and so forth.

The neural network can reflect the architecture defined in neural network description. In this non-limiting example, the neural network includes an input layer, which includes input data, which can be any type of data such as media content (images, videos, etc.), numbers, text, etc., associated with the corresponding input data described above with reference to FIGS. 1-4. In one illustrative example, the input layer can process data representing a portion of the input media data, such as a patch of data or pixels (e.g., a 128×128 patch of data) in an image corresponding to the input media data.

The neural network can include one or more hidden layers. The hidden layers can include n number of hidden layers, where n is an integer greater than or equal to one. The number of hidden layers can include as many layers as needed for a desired processing outcome and/or rendering intent. The neural network further includes an output layer that provides an output resulting from the processing performed by the hidden layers.

The neural network, in this example, is a multi-layer neural network of interconnected nodes. Each node can represent a piece of information. Information associated with the nodes is shared among the different layers and each layer retains information as information is processed. In some cases, the neural network can include a feed-forward neural network, in which case there are no feedback connections where outputs of the neural network are fed back into itself. In other cases, the neural network can include a recurrent neural network, which can have loops that allow information to be carried across nodes while reading in input.

Information can be exchanged between nodes through node-to-node interconnections between the various layers. Nodes of the input layer can activate a set of nodes in the first hidden layer. For example, as shown, each input node of the input layer is connected to each node of the first hidden layer. Nodes of the first hidden layer can transform the information of each input node by applying activation functions to the information. The information derived from the transformation can then be passed to and can activate the nodes of the next hidden layer, which can perform their own designated functions. Example functions include convolutional, up-sampling, data transformation, pooling, and/or any other suitable functions. The output of the hidden layer (e.g.,) can then activate nodes of the next hidden layer, and so on. The output of the last hidden layer can activate one or more nodes of the output layer, at which point an output is provided. In some cases, while nodes in the neural network are shown as having multiple output lines, a node has a single output and all lines shown as being output from a node represent the same output value.

In some cases, each node or interconnection between nodes can have a weight that is a set of parameters derived from training the neural network. For example, an interconnection between nodes can represent a piece of information learned about the interconnected nodes. The interconnection can have a numeric weight that can be tuned (e.g., based on a training dataset), allowing the neural network to be adaptive to inputs and able to learn as more data is processed.

In some instances, the neural network is pre-trained to process the features from the data in the input layer using different hidden layers in order to provide the output through the output layer.

The neural network can include any suitable neural or deep learning type of network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network can represent any other neural or deep learning network, such as an autoencoder, deep belief nets (DBNs), recurrent neural networks (RNNs), etc.

Neural Architecture Search (NAS) involves a process in which neural controller searches through various types of neural networks such as CNNs, DBNs, RNNs, etc., to determine which type of neural network, given the input/output description of neural network description, can perform closes to the desired output once trained. This search process is currently cumbersome and resource intensive, because every type of available neural network is treated as a “blackbox.” In other words, a neural controller selects an available neural network (a blackbox), trains it, validates it and either selects it or not depending on the validation result. However, each available example or type of neural network is a collection of nodes. As will be described below, the present disclosure enables gaining insight into performance of each individual node to assess its performance, which then allows the system to select a hybrid structure of nodes that may or may not be the same as a given particular structure of a neural network currently available. In other words, the present disclosure enables an AutoML system to pick and choose nodes from different available neural networks and create a new structure that performs best for a given application.

In addition to the neural network, the machine-learning model can include any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like.

### B. Training

Once the initial prompt machine-learning model 806 is selected, the training subsystem 804 can train the prompt machine-learning model 806 using a training dataset accessed from a training database 810. Various training and test data sets may be utilized to train the machine-learning model such that once trained, the prompt machine-learning model 806 can generate one or more prompts that can be processed by the LLM to generate customized content. In some instances, the training dataset can include historical content and training labels that include corresponding prompts. Additionally or alternatively, the training dataset can also include domain and persona data associated with the historical content.

A large pool of data accessed from the training database 810 may be split into two classes of data called training data set and test data set. For example, 70% of the accessed data from the pool may be used as part of the training data set while the remaining 30% of the accessed data from the pool may be used as part of the test data set. The percentages according to which the pool of the data are split into training data set and test data set is not limited to 70/30 and may be set according to a configurable accuracy requirement and/or error tolerance (e.g., the split can be 50/50, 60/40, 70/30, 80/20, 90/10, etc. between the two data sets).

The training subsystem 804 can then use the training dataset to train the prompt machine-learning model 806 by calculating a loss based on a comparison between an output generated from the machine-learning model and a corresponding label of the training data. With each output generated by the prompt machine-learning model 806, the label can thus be used to correct the output of the prompt machine-learning model 806. In some instances, manual feedback is further utilized to adjust the corresponding parameters of the machine-learning model. As noted, weights of different nodes of the prompt machine-learning model 806 may be adjusted/tuned during the training process to improve resulting output.

During training, weights of nodes associated with the prompt machine-learning model 806 can be adjusted using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training media data until the weights of the layers are accurately tuned. In particular, the training of the prompt machine-learning model 806 (e.g., adjustment of the weights) can be performed until a corresponding loss (e.g., a mean square error) reaches a minimum threshold.

Once trained, the training subsystem 804 can test the prompt machine-learning model 806 using the test data set. Examples of testing methods can include regression testing, unit testing, beta testing, and alpha testing. Once the result of testing the prompt machine-learning model 806 is satisfactory (e.g., when outputs of the testing stage is greater than or equal to a threshold or incorrect detections are less than a threshold), the training subsystem 804 can deploy the trained prompt machine-learning model 806 (which may also be referred to as a trained machine learning model or machine trained neural network) to a prompt generator 822, which can use the trained prompt machine-learning model 806 to generate prompts for the customized content.

### C. Deployment

After accessing the trained prompt machine-learning model 806, the content-generation application can proceed with a deployment phase 812, in which the prompt generator 822 applies the trained prompt machine-learning model 806 to input data to generate the prompts for generating the customized content. The input data for the trained machine-learning model can include initial content 814, content format 816, and optional supplemental data 818.

The initial content 814 can include text, images, and/or other types of data that can be processed and formatted to generate customized content. The initial content can include content generated by applying an initial machine-learning model to raw data provided by the target recipient and/or another user. The content format 816 can specify how the customized content is to be formatted for a target recipient. Examples of the content format can include an email, a memorandum, a slide deck, an executive briefing, spreadsheets, or mitigation strategies (e.g., media buying, media messaging, media approach, PR strategy, PR approach). The supplemental data 818 can include: (i) persona data that identifies characteristics associated with the target recipient (e.g., CEO, CISO, CCO, CMO); and/or (ii) domain data that identifies characteristics associated with a domain associated with the customized content (e.g., cybersecurity, national security, healthcare, finance, energy).

An encoding module 820 can then encode the initial content 814, the content format 816, and the optional supplemental data 818 to generate a feature vector. The feature vector can include a set of values (e.g., a numerical array) that represent the input data, in which the feature vector can be used as input to the prompt machine-learning model 806. Example techniques for generating feature vectors can include term frequency-inverse document frequency (TF-IDF) techniques, word-embedding techniques, and tokenization techniques.

The prompt generator 822 can then apply the trained prompt machine-learning model 806 (e.g., the neural network) to the feature vector to generate prompts 824 that can be outputted for additional processing by the content machine-learning model. The prompts 824 can include text data for querying the content machine-learning model to generate the customized content. In some instances, the prompts can be modified via a user-provided input. Example prompts can include instructions, questions, or any other types of text input.

### IV. Example Systems

FIG. 9 illustrates a computing system architecture 900, including various components in electrical communication with each other, in accordance with some embodiments. The example computing system architecture 900 illustrated in FIG. 9 includes a computing device 902, which has various components in electrical communication with each other using a connection 906, such as a bus, in accordance with some implementations. The example computing system architecture 900 includes a processing unit 904 that is in electrical communication with various system components, using the connection 906, and including the system memory 914. In some embodiments, the system memory 914 includes read-only memory (ROM), random-access memory (RAM), and other such memory technologies including, but not limited to, those described herein. In some embodiments, the example computing system architecture 900 includes a cache 908 of high-speed memory connected directly with, in close proximity to, or integrated as part of the processor 904. The system architecture 900 can copy data from the memory 914 and/or the storage device 910 to the cache 908 for quick access by the processor 904. In this way, the cache 908 can provide a performance boost that decreases or eliminates processor delays in the processor 904 due to waiting for data. Using modules, methods and services such as those described herein, the processor 904 can be configured to perform various actions. In some embodiments, the cache 908 may include multiple types of cache including, for example, level one (L1) and level two (L2) cache. The memory 914 may be referred to herein as system memory or computer system memory. The memory 914 may include, at various times, elements of an operating system, one or more applications, data associated with the operating system or the one or more applications, or other such data associated with the computing device 902.

Other system memory 914 can be available for use as well. The memory 914 can include multiple different types of memory with different performance characteristics. The processor 904 can include any general purpose processor and one or more hardware or software services, such as service 912 stored in storage device 910, configured to control the processor 904 as well as a special-purpose processor where software instructions are incorporated into the actual processor design. The processor 904 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 904 can be a microprocessor, a microcontroller, a digital signal processor (“DSP”), or a combination of these and/or other types of processors. In some embodiments, the processor 904 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 900, an input device 916 can represent any number of input mechanisms, such as a microphone for speech, a touch-sensitive screen for gesture or graphical input, keyboard, mouse, motion input, pen, and other such input devices. An output device 918 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 900. In some embodiments, the input device 916 and/or the output device 918 can be coupled to the computing device 902 using a remote connection device such as, for example, a communication interface such as the network interface 920 described herein. In such embodiments, the communication interface can govern and manage the input and output received from the attached input device 916 and/or output device 918. As may be contemplated, there is no restriction on operating on any particular hardware arrangement and accordingly the basic features here may easily be substituted for other hardware, software, or firmware arrangements as they are developed.

In some embodiments, the storage device 910 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 910 can include hardware and/or software services such as service 912 that can control or configure the processor 904 to perform one or more functions including, but not limited to, the methods, processes, functions, systems, and services described herein in various embodiments. In some embodiments, the hardware or software services can be implemented as modules. As illustrated in example computing system architecture 900, the storage device 910 can be connected to other parts of the computing device 902 using the system connection 906. In some embodiments, a hardware service or hardware module such as service 912, that performs a function can include a software component stored in a non-transitory computer-readable medium that, in connection with the necessary hardware components, such as the processor 904, connection 906, cache 908, storage device 910, memory 914, input device 916, output device 918, and so forth, can carry out the functions such as those described herein.

The disclosed systems and service of a content-generation application (e.g., the content-generation application 102 described herein at least in connection with FIG. 1) can be performed using a computing system such as the example computing system illustrated in FIG. 9, using one or more components of the example computing system architecture 900. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for generating customized content based on extracted insights described herein by, for example, executing code using a processor such as processor 904 wherein the code is stored in memory such as memory 914 as described herein. One or more of a user device, a provider server or system, a database system, or other such devices, services, or systems may include some or all of the components of the computing system such as the example computing system illustrated in FIG. 9, using one or more components of the example computing system architecture 900 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 928. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 904 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 914 can be coupled to the processor 904 by, for example, a connector such as connector 906, or a bus. As used herein, a connector or bus such as connector 906 is a communications system that transfers data between components within the computing device 902 and may, in some embodiments, be used to transfer data between computing devices. The connector 906 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 914 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 914 can also include magnetic or optical data storage media including read-only (e.g., CD ROM and DVD ROM) or otherwise (e.g., CD or DVD). The memory can be local, remote, or distributed.

As described above, the connector 906 (or bus) can also couple the processor 904 to the storage device 910, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data.

Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 910. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 906 can also couple the processor 904 to a network interface device such as the network interface 920. The interface can include one or more of a modem or other such network interfaces including, but not limited to those described herein. It will be appreciated that the network interface 920 may be considered to be part of the computing device 902 or may be separate from the computing device 902. The network interface 920 can include one or more of an analog modem, Integrated Services Digital Network (ISDN) modem, cable modem, token ring interface, satellite transmission interface, or other interfaces for coupling a computer system to other computer systems. In some embodiments, the network interface 920 can include one or more input and/or output (I/O) devices. The I/O devices can include, by way of example but not limitation, input devices such as input device 916 and/or output devices such as output device 918. For example, the network interface 920 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 902 can be connected to one or more additional computing devices such as computing device 924 via a network 922 using a connection such as the network interface 920. In such embodiments, the computing device 924 may execute one or more services 926 to perform one or more functions under the control of, or on behalf of, programs and/or services operating on computing device 902. In some embodiments, a computing device such as computing device 924 may include one or more of the types of components as described in connection with computing device 902 including, but not limited to, a processor such as processor 904, a connection such as connection 906, a cache such as cache 908, a storage device such as storage device 910, memory such as memory 914, an input device such as input device 916, and an output device such as output device 918. In such embodiments, the computing device 924 can carry out the functions such as those described herein in connection with computing device 902. In some embodiments, the computing device 902 can be connected to a plurality of computing devices such as computing device 924, each of which may also be connected to a plurality of computing devices such as computing device 924. Such an embodiment may be referred to herein as a distributed computing environment.

The network 922 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IOT network) or any other such network or combination of networks. Communications via the network 922 can be wired connections, wireless connections, or combinations thereof. Communications via the network 922 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 922, within the computing device 902, within the computing device 924, or within the computing resources provider 928 can include information, which also may be referred to herein as content. The information may include text, graphics, audio, video, haptics, and/or any other information that can be provided to a user of the computing device such as the computing device 902. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 902 and presented to a user of the computing device 902 using forms that are perceptible via sight, sound, smell, taste, touch, or other such mechanisms. In some embodiments, communications over the network 922 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 902 and/or the computing device 924 can be connected to a computing resources provider 928 via the network 922 using a network interface such as those described herein (e.g. network interface 920). In such embodiments, one or more systems (e.g., service 930 and service 932) hosted within the computing resources provider 928 (also referred to herein as within “a computing resources provider environment”) may execute one or more services to perform one or more functions under the control of, or on behalf of, programs and/or services operating on computing device 902 and/or computing device 924. Systems such as service 930 and service 932 may include one or more computing devices such as those described herein to execute computer code to perform the one or more functions under the control of, or on behalf of, programs and/or services operating on computing device 902 and/or computing device 924.

For example, the computing resources provider 928 may provide a service, operating on service 930 to store data for the computing device 902 when, for example, the amount of data that the computing device 902 exceeds the capacity of storage device 910. In another example, the computing resources provider 928 may provide a service to first instantiate a virtual machine (VM) on service 932, use that VM to access the data stored on service 932, perform one or more operations on that data, and provide a result of those one or more operations to the computing device 902. Such operations (e.g., data storage and VM instantiation) may be referred to herein as operating “in the cloud,” “within a cloud computing environment,” or “within a hosted virtual machine environment,” and the computing resources provider 928 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 928 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 930 and service 932 may implement versions of various services (e.g., the service 912 or the service 926) on behalf of, or under the control of, computing device 902 and/or computing device 924. Such implemented versions of various services may involve one or more virtualization techniques so that, for example, it may appear to a user of computing device 902 that the service 912 is executing on the computing device 902 when the service is executing on, for example, service 930. As may also be contemplated, the various services operating within the computing resources provider 928 environment may be distributed among various systems within the environment as well as partially distributed onto computing device 924 and/or computing device 902.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 200 of FIG. 2). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually affect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term.

Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
accessing input data that includes initial content;
determining a content format of customized content to be generated by processing the input data, wherein the content format specifies how the customized content is to be formatted for a target recipient;
generating one or more prompts to be processed by a content machine-learning model for generating the customized content, wherein the one or more prompts are generated based on the input data and the content format;
applying the content machine-learning model to the one or more prompts to generate the customized content; and
outputting the customized content.

2. The computer-implemented method of claim 1, further comprising determining persona data that identifies characteristics associated with the target recipient, wherein the one or more prompts are generated further based on the persona data.

3. The computer-implemented method of claim 1, further comprising determining domain data that identifies characteristics associated with a domain associated with the customized content, wherein the one or more prompts are generated further based on the domain data.

4. The computer-implemented method of claim 1, wherein the initial content is previously generated by applying an initial machine-learning model to raw data.

5. The computer-implemented method of claim 1, wherein generating the one or more prompts includes applying a prompt machine-learning model to the input data and the content format to generate the one or more prompts.

6. The computer-implemented method of claim 1, wherein the content format includes an email, a memorandum, a slide deck, an executive briefing, or mitigation strategies.

7. The computer-implemented method of claim 1, further comprising:
receiving feedback associated with the customized content; and
updating parameters of the content machine-learning model based on the feedback.

8. A system comprising:
one or more processors; and
memory storing thereon instructions that, as a result of being executed by the one or more processors, cause the system to perform operations comprising:
accessing input data that includes initial content;
determining a content format of customized content to be generated by processing the input data, wherein the content format specifies how the customized content is to be formatted for a target recipient;
generating one or more prompts to be processed by a content machine-learning model for generating the customized content, wherein the one or more prompts are generated based on the input data and the content format;
applying the content machine-learning model to the one or more prompts to generate the customized content; and
outputting the customized content.

9. The system of claim 8, further comprising determining persona data that identifies characteristics associated with the target recipient, wherein the one or more prompts are generated further based on the persona data.

10. The system of claim 8, further comprising determining domain data that identifies characteristics associated with a domain associated with the customized content, wherein the one or more prompts are generated further based on the domain data.

11. The system of claim 8, wherein the initial content is previously generated by applying an initial machine-learning model to raw data.

12. The system of claim 8, wherein generating the one or more prompts includes applying a prompt machine-learning model to the input data and the content format to generate the one or more prompts.

13. The system of claim 8, wherein the content format includes an email, a memorandum, a slide deck, an executive briefing, or mitigation strategies.

14. The system of claim 8, further comprising:
receiving feedback associated with the customized content; and
updating parameters of the content machine-learning model based on the feedback.

15. A non-transitory, computer-readable storage medium storing thereon executable instructions that, as a result of being executed by one or more processors of a computer system, cause the computer system to perform operations comprising:
accessing input data that includes initial content;
determining a content format of customized content to be generated by processing the input data, wherein the content format specifies how the customized content is to be formatted for a target recipient;
generating one or more prompts to be processed by a content machine-learning model for generating the customized content, wherein the one or more prompts are generated based on the input data and the content format;
applying the content machine-learning model to the one or more prompts to generate the customized content; and
outputting the customized content.

16. The non-transitory, computer-readable storage medium of claim 15, further comprising determining persona data that identifies characteristics associated with the target recipient, wherein the one or more prompts are generated further based on the persona data.

17. The non-transitory, computer-readable storage medium of claim 15, further comprising determining domain data that identifies characteristics associated with a domain associated with the customized content, wherein the one or more prompts are generated further based on the domain data.

18. The non-transitory, computer-readable storage medium of claim 15, wherein the initial content is previously generated by applying an initial machine-learning model to raw data.

19. The non-transitory, computer-readable storage medium of claim 15, wherein generating the one or more prompts includes applying a prompt machine-learning model to the input data and the content format to generate the one or more prompts.

20. The non-transitory, computer-readable storage medium of claim 15, further comprising:
receiving feedback associated with the customized content; and
updating parameters of the content machine-learning model based on the feedback.
